(19) United States
(12) Patent Application Publication
(10) Pub. No.: US 2026/0341194 A1
(43) Pub. Date: Oct. 29, 2026

(54) ELECTRONIC DEVICE

(71) Applicant: Samsung Display Co., Ltd., Yongin-Si (KR)

(72) Inventors: Sooyeon LEE, Yongin-si (KR); YUNKI BAEK, Yongin-si (KR)

(21) Appl. No.: 19/459,505

(22) Filed: Jan. 26, 2026

(30) Foreign Application Priority Data
Apr. 25, 2025 (KR) 10-2025-0054631

(51) Int. Cl. G09G 3/20; G09G 3/00; H04N 13/344; H04N 13/398

(52) U.S. Cl. CPC G09G 3/2096; G09G 3/002; G09G 3/003; H04N 13/344; H04N 13/398; G09G 2320/0257; G09G 2320/045; G09G 2320/048; G09G 2340/0464; G09G 2340/16; G09G 2354/00

(57) ABSTRACT

An electronic device includes a first display panel, a second display panel and a driving controller. The driving controller includes a memory, an accumulation unit that read a previous accumulated signal from the memory and restore a left-eye accumulated signal and a right-eye accumulated signal, and a compensation unit that output the left-eye image signal based on the left-eye input signal and the left-eye accumulated signals, and output the right-eye image signal according to the right-eye input signal or the right-eye accumulated signals. The accumulation unit generates a current signal based on an entirety of the left-eye image signal and a portion of the right-eye image signal or an entirety of a right-eye image signal and a portion of a left-eye image signal, and stores a current accumulated signal obtained by adding the previous accumulated signal and the current signal in the memory.

### CROSS-REFERENCE TO RELATED APPLICATIONS

This application claims priority under 35 U.S.C. § 119 to Korean Patent Application No. 10-2025-0054631 filed on Apr.25, 2025, in the Korean Intellectual Property Office, the disclosures of which are incorporated by reference herein in their entireties.

### BACKGROUND

The present disclosure relates to an electronic device for displaying an image.

An electronic device such as a television, a mobile phone, a tablet computer, a navigation system, a game machine, or the like generates an image and provides the generated image to a user through a display module.

A display module of an electronic device includes a plurality of pixels and driving circuits that control an image to be displayed in the plurality of pixels. Each of the plurality of pixels includes a light-emitting element and transistors that control the light-emitting element. The light-emitting elements and transistors of each of the pixels may deteriorate according to operation time.

### SUMMARY

The present disclosure provides an electronic device capable of compensating for deterioration of pixels.

An embodiment of an electronic device comprises a first display panel that displays an image corresponding to a left-eye image signal, a second display panel that display an image corresponding to a right-eye image signal, and a driving controller that receives a left-eye input signal and a right-eye input signal and outputs the left-eye image signal and the right-eye image signals. The driving controller comprises a memory, an accumulation unit that reads a previous accumulated signal from the memory to restore a left-eye accumulated signal and a right-eye accumulated signal, and a compensation unit that outputs the left-eye image signal based on the left-eye input signal and the left-eye accumulated signal, and outputs the right-eye image signal based on the right-eye input signal and the right-eye accumulated signal. The accumulation unit generates a current signal based on an entirety of the left-eye image signal and a portion of the right-eye image signal or an entirety of the right-eye image signal and a portion of the left-eye image signal, and stores a current accumulated signal obtained by adding the previous accumulated signal and the current signal in the memory.

In an embodiment, the current accumulated signal stored in the memory in a current frame may be provided to the accumulation unit as the previous accumulated signal in a next frame.

In an embodiment, the compensation unit may add the left-eye compensation value to a left-eye input signal to generate the left-eye image signal, and may add a right-eye compensation value to the right-eye input signal to generate the right-eye image signal.

In an embodiment, the left-eye image signal comprises a first portion and a second portion, the right-eye image signal comprises a first portion and a second portion, and the second portion of the left-eye image signal and the first portion of the right-eye image signal may be the same as each other.

In an embodiment, the accumulation unit may generate the current signal by combining the entirety of the left-eye image signal and the second portion of the right-eye image signal.

In an embodiment, the left-eye image signal may correspond to a viewport by a left-eye of a user, and the left-eye image signal may correspond to a viewport by a right-eye of the user.

In an embodiment, the accumulation unit may restore a portion corresponding to the entirety of the left-eye image signal from among the previous accumulated signal from the memory as the left-eye accumulated signal, and may restore the right-eye accumulated signal by combining the second portion of the left-eye image signal and a portion corresponding to the second portion of the right-eye image signal.

An embodiment of an electronic device comprises a first display panel for displaying an image corresponding to a left-eye image signal, a second display panel for displaying an image corresponding to a right-eye image signal and a driving controller that receives a left-eye input signal and a right-eye input signal, and outputs the left-eye image signals and the right-eye image signals, wherein the driving controller comprises a memory, an image shifter that outputs a shift information during a shift mode, and a coordinate determiner for determining a shift position of the left-eye input signal and a shift position of the right-eye input signal based on the shift information, reading a left-eye peripheral signal and a right-eye peripheral signal from the memory based on a determined shift position, and providing a left-eye shift signal and a right-eye shift signal to the image shifter. The image shifter outputs the left-eye image signal and the right-eye image signal based on the left-eye shift signal and the right-eye shift signal.

In an embodiment, the coordinate determiner may receive the left-eye image signal and the right-eye image signal from the image shifter, and store the left-eye image signal and the right-eye image signal in the memory as a left-eye current signal and a right-eye current signal.

In an embodiment, the shift information may include a shift enable flag indicating the shift mode.

In an embodiment, the shift information may further include a size and an initial viewport position of each of the left-eye input signal and the right-eye input signal.

In an embodiment, the shift information may further include a shift distance, a shift period, and a shift direction of each of the left-eye input signal and the right-eye input signal.

In an embodiment, the memory stores an image signal corresponding to a 360-degree image, and the coordinate determiner may read the left-eye peripheral signal and the right-eye peripheral signal among the image signal stored in the memory according to the determined shift position.

An embodiment of an electronic device comprises a display panel including a first display region for displaying an image corresponding to a left-eye image signal and a second display region for displaying an image corresponding to a right-eye image signal, and a driving controller that receives a left-eye input signal and a right-eye input signal, and outputs the left-eye image signal and the right-eye image signal. The driving controller comprises a memory, an accumulation unit that reads a previous accumulated signal from the memory and restore a left-eye accumulated signal and a right-eye accumulated signal, and a compensation unit that outputs the left-eye image signal based on the left-eye input signal and the left-eye accumulated signals, and outputs the right-eye image signal based on the right-eye input signal or the right-eye accumulated signals. The accumulation unit generates a current signal based on an entirety of the left-eye image signal and a portion of the right-eye image signal or an entirety of the right-eye image signal and a portion of the left-eye image signal, and stores a current accumulated signal obtained by adding the previous accumulated signal and the current signal in the memory.

In an embodiment, the current accumulated signal stored in the memory in a current frame may be provided to the accumulation unit as the previous accumulated signal in a next frame.

In an embodiment, the compensation unit may add the left-eye compensation value to a left-eye input signal to generate the left-eye image signal, and add a right-eye compensation value to the right-eye input signal to generate the right-eye image signal.

In an embodiment, the left-eye image signal includes a first portion and a second portion, the right-eye image signal includes a first portion and a second portion, and the second portion of the left-eye image signal and the first portion of the right-eye image signals may be the same as each other.

In an embodiment, the accumulation unit may generate the current signal by combining the entirety of the left-eye image signal and the second portion of the right-eye image signal.

In an embodiment, the left-eye image signal may correspond to a viewport by a left-eye of a user, and the left-eye image signal may correspond to the viewport by a right-eye of the user.

In an embodiment, the accumulation unit may restore a portion corresponding to the entirety of the left-eye image signal from among the previous accumulated signal from the memory as the left-eye accumulated signal, and may restore the right-eye accumulated signal by combining the second portion of the left-eye image signal and a portion corresponding to the second portion of the right-eye image signal.

### BRIEF DESCRIPTION OF THE FIGURES

FIG. 1 is a block diagram of an electronic device according to an embodiment.

FIG. 2 is a schematic diagram of an electronic device according to various embodiments.

FIG. 3 is a front view of an electronic device according to an embodiment of the present disclosure.

FIG. 4 is a block diagram illustrating a display module according to an embodiment of the present disclosure.

FIG. 5 is a block diagram of a driving controller according to an embodiment of the present disclosure.

FIG. 6A is a diagram illustrating an example of a left-eye image signal and a right-eye image signal.

FIG. 6B is an overlapping view of the left-eye image signal and the right-eye image signal shown in FIG. 6A.

FIG. 7 is a block diagram of a driving controller according to an embodiment of the present disclosure.

FIG. 8 illustrates an example of a left-eye image signal corresponding to a left-eye input signal and a right-eye image signal corresponds to a right-eye input signal.

FIG. 9 is a illustrating an electronic device according to an embodiment of the present disclosure.

### DETAILED DESCRIPTION

In this specification, it will be understood that when an element (or a region, a layer, a portion, or the like) is referred to as being "on", "connected to" or "coupled to" another element, it can be directly arranged on, connected to, or coupled to the other element or layer or other elements may be arranged therebetween.

Like reference numerals or symbols refer to like elements throughout. In the drawings, the thickness, ratio, and size of the elements are exaggerated for effectively describing the technical contents.

It will be understood that, although the terms “first”, “second”, etc. may be used herein to describe various elements, the elements are not to be limited by these terms. These terms are only used to distinguish one element from another element. For instance, a first element discussed below could be termed a second element without departing from the scope of the inventive concept. Similarly, a second element could be termed a first element. In this specification, the singular expressions "a", "an" and "the" are intended to include the plural forms as well, unless the context clearly indicates otherwise.

In addition, the terms "below", “under”, "on the lower side", "above", “over”, "on the upper side", or the like may be used to describe the relationships between the elements illustrated in the drawings. These terms are relative concepts and are described on the basis of the directions indicated in the drawings.

It will be further understood that the terms "comprises”, “includes, and “has" as well as variations such as "comprising”, “including”, “having", when used in this specification, specify the presence of stated features, numbers, steps, operations, elements, components, or combinations thereof, but do not preclude the possibility of the presence or addition of one or more other features, numbers, steps, operations, elements, components, or combinations thereof.

Unless otherwise defined, all terms (including technical and scientific terms) used herein have the same meaning as commonly understood by one of ordinary skills in the art to which this disclosure belongs. It will be further understood that terms, such as those defined in commonly used dictionaries, should be interpreted as having a meaning that is consistent with their meaning in the context of the relevant art and will not be interpreted in an idealized or overly formal sense unless expressly so defined herein.

Hereinafter, embodiments of the present disclosure will be described with reference to the drawings.

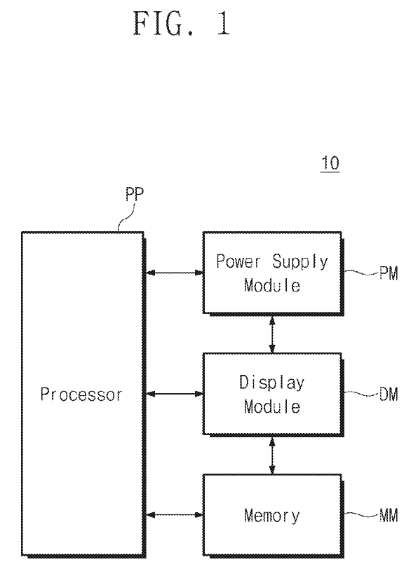

FIG. 1 is a block diagram of an electronic device 10 according to an embodiment.

Referring to FIG. 1, an electronic device 10 according to an embodiment may include a display module DM, a processor PP, a memory MM, and a power supply module PM.

The processor PP may include at least one of a central processing unit (CPU), an application processor (AP), a graphics processing unit (GPU), a communication processor (CP), an image signal processor (ISP), and a controller.

The memory MM may store data information necessary for the operation of the processor PP or the display module DM. When the processor PP executes an application stored in the memory MM, an image data signal and an input control signal may be transmitted to the display module DM, and the display module DM may process the received signals and output image information through a display screen.

The power supply module PM may include a power supply module such as a power adapter or a battery device, and a power conversion module that converts power supplied by the power supply module to generate power required for operation of the electronic device 10.

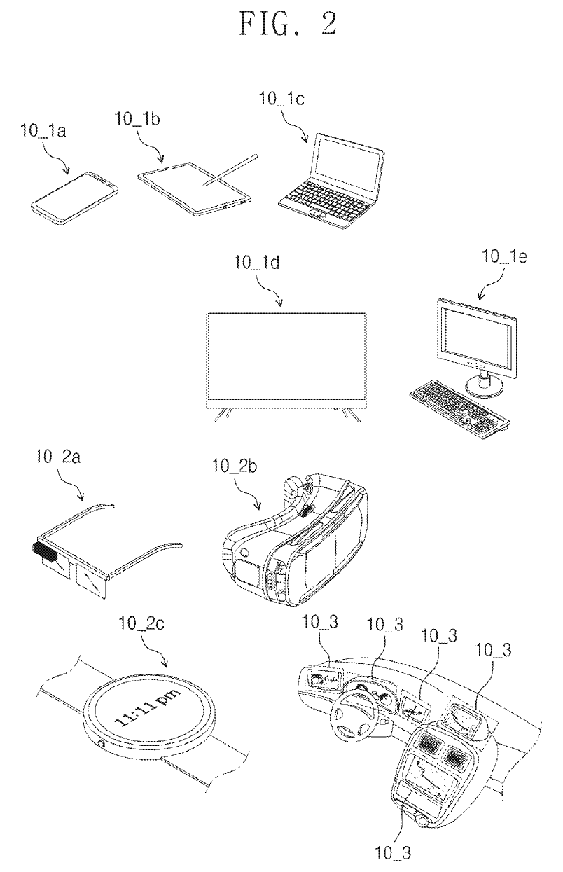

FIG. 2 is schematic diagrams of electronic devices according to various embodiments.

Referring to FIG. 2, various electronic devices according to embodiments may include an electronic device for displaying an image such as a smartphone 10_1a, a tablet PC 10_1b, a laptop 10_1c, a TV 10_1d, and a desk monitor 10_1e, and the like, as well as a wearable electronic device including a display module such as smart glasses 10_2a, a head mounted display 10_2b, a smart watch 10_2c, and the like, an electronic device for a vehicle 10_3 including a display module, such as a CID (Center Information Display), a room mirror display, and the like arranged on an instrument panel, a center fascia, and a dashboard of a vehicle, and the like.

FIG. 3 illustrates an electronic device according to an embodiment of the present disclosure.

In FIG. 3, smart glasses are illustrated as an example of the electronic device 10, but the present disclosure is not limited thereto.

Referring to FIG. 3, the electronic device 10 may be used to implement augmented reality or virtual reality. The electronic device 10 for implementing augmented reality may provide a virtual graphic image through a translucent display. In this case, a user can simultaneously view the virtual graphic image and the real object. The electronic device 10 for implementing virtual reality may provide a virtual graphic image. The user may experience virtual reality through virtual content.

The electronic device 10 includes a first display panel DP1 and a second display panel DP2. However, the present disclosure is not limited thereto. The electronic device 10 may include one display panel that is not divided into the first display panel DP1 and the second display panel DP2. In this case, the display panel may be divided into a first display region and a second display region.

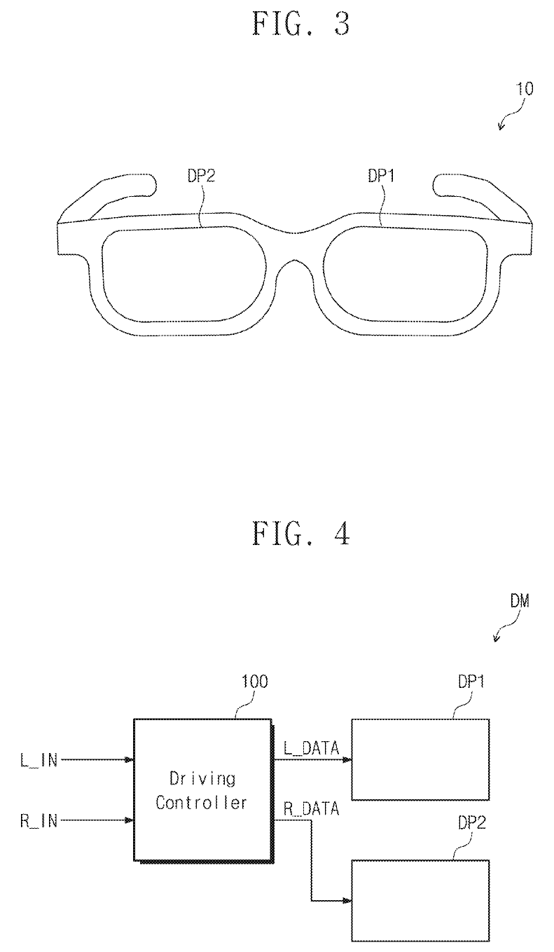

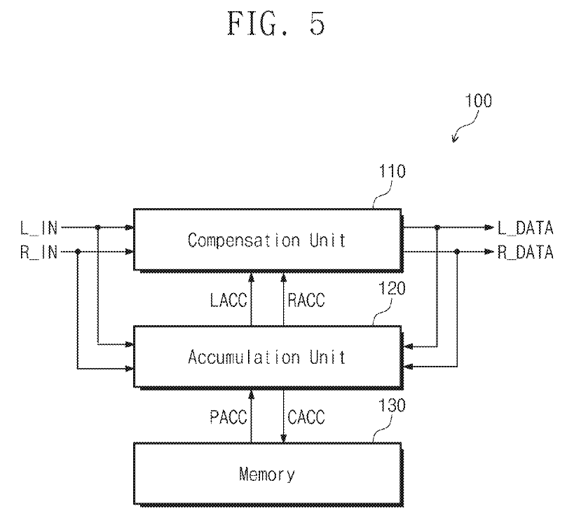

FIG. 4 is a diagram illustrating a display module DM according to an embodiment of the present disclosure.

The display module DM includes a driving controller 100, a first display panel DP1, and a second display panel DP2. The driving controller 100 receives the left-eye input signal L_IN and the right-eye input signal R_IN. The left-eye input signal L_IN and the right-eye input signal R_IN may be provided from the processor 12 shown in FIG. 1.

The driving controller 100 may output a left-eye image signal L_DATA and a right-eye image signal R_DATA corresponding to the left-eye input signal L_IN and the right-eye input signal R_IN, respectively.

In an embodiment, the driving controller 100 may accumulate the left-eye image signal L_DATA and the right-eye image signal R_DATA, and predict the degree of deterioration of the pixels in the first and second display panels DP1, DP2 based on the accumulated left-eye image signal L_DATA and the accumulated right-eye image signal R_DATA.

The driving controller 100 corrects the left-eye input signal L_IN and the right-eye input signal R_IN based on the predicted degree of deterioration to output the left-eye image signal L_DATA and the right-eyed image signal R_DATA.

FIG. 5 is a block diagram of the driving controller 100 according to an embodiment of the present disclosure.

Referring to FIG. 5, the driving controller 100 includes a compensation unit 110, an accumulation unit 120, and a memory 130. The compensation unit 110 and the accumulation unit 120 may be implemented by one or more integrated circuits.

The compensation unit 110 receives the left-eye input signal L_IN and the right-eye input signal R_IN, and outputs the left-eye image signal L_DATA and the right-eye image signal R_DATA.

The compensation unit 110 may calculate a left-eye compensation value and a right-eye compensation value based on a left-eye accumulated signal LACC and a right-eye accumulated signal RACC provided from the accumulation unit 120. The compensation unit 110 may add the left-eye compensation value and the right-eye compensation value to the left-eye input signal L_IN and the right-eye input signal R_IN, respectively, and output the left-eye image signal L_DATA and the right-eyed image signal R_DATA.

When the left-eye input signal L_IN and the right-eye input signal R_IN are input, the accumulation unit 120 reads a previous accumulated signal PACC corresponding to the left-eye input signal L_IN and right-eye input signal R_IN from the memory 130. The accumulation unit 120 may restore the previous accumulated signal PACC to the left-eye accumulated signal LACC and the right-eye accumulated signal RACC, and provide the restored left-eye accumulated signal LACC and the restored right-eye accumulated signal RACC to the compensation unit 110.

The accumulation unit 120 generates a current signal based on the left-eye image signal L_DATA and the right-eye image signal R_DATA output from the compensation unit 110, and adds the previous accumulated signal PACC and the current signal to calculate the current accumulated signal CACC. The accumulation unit 120 stores the current accumulation signal CACC in the memory 130.

Each of the first display panel DP1 and the second display panel DP2 illustrated in FIG. 4 includes a pixel. The pixel includes a light-emitting element and a plurality of transistors. The light-emitting element and the plurality of transistors may deteriorate according to operation time. In particular, a light-emitting element, such as a light-emitting diode, may deteriorate according to various operation environments, such as the operation time, a displayed gray level (or luminance), an ambient temperature, and an ambient brightness. When the characteristics of a pixel deteriorate, an afterimage phenomenon may occur in which a previous image affects a next image.

The compensation unit 110 may store the compensation value according to a deterioration environment (for example, the operation time and the displayed gray level) in a storage device such as a lookup table in advance. Information on the deterioration environment may be provided by the accumulation unit 120. The previous accumulation signal PACC provided from the accumulation unit 120 may be information on the deterioration environment.

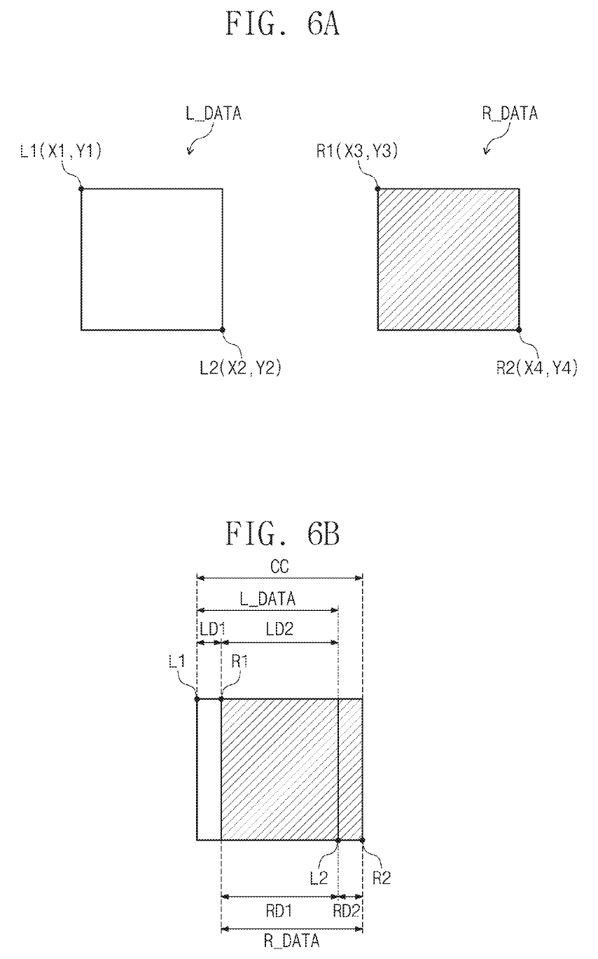

FIG. 6A is a diagram illustrating an example of the left-eye image signal L_DATA and the right-eye image signal R_DATA.

Referring to FIGS. 4 and 6A, the left-eye image signal L_DATA is an image signal to be displayed on the first display panel DP1. The left-eye image signal L_DATA may include an image signal of a region defined by the point L1 and the point L2. The position of the point L1 may be denoted by L1(X1, Y1), and the position of the point L2 may be denoted as L2(X2, Y2).

The right-eye image signal R_DATA is an image signal to be displayed on the second display panel DP2. The right-eye image signal R_DATA may include an image signal of a region defined by the point R1 and the point R2. The position of the point R1 may be denoted by R1(X3, Y3), and the position of the point R2 may be denoted as R2(X4, Y4).

In order to display a three-dimensional (3D) image on the electronic device 10, position information (or region information) according to the position viewed by the user and information on the image signal of the region to be displayed are required. The position information (or region information) may include position information of the points L1, L2, R1, and R2, that is, L1(X1, Y1), L2(X2, Y2), R1(X3, Y3), and R2(X4, Y4).

The area defined by the position information L1(X1, Y1), L2(X2, Y2), R1(X3, Y3), and R2(X4, Y4) may be defined as an area viewed by the user, that is, a viewport. The position information L1(X1, Y1) and L2(X2, Y2) is a viewport viewed by the left-eye, and the position information R1(X3, Y3) and R2(X4, Y4) is a viewport viewed by the right-eye. That is, the left-eye image signal L_DATA may correspond to a viewport by the left-eye of the user, and the right-eye image signal R_DATA may correspond to a viewport of the right-eye of the user.

FIG. 6B is a diagram illustrating the left-eye image signal L_DATA and the right-eye image signal R_DATA shown in FIG. 6A superimposed on each other.

Referring to FIGS. 4 and 6B, the left-eye image signal L_DATA includes a first portion LD1 and a second portion LD2. The right-eye image signal R_DATA includes a first portion RD1 and a second portion RD2. The second portion LD2 of the left-eye image signal L_DATA and the first portion RD1 of the right-eye image signal R_DATA are the same as each other. When the second portion LD2 of the left-eye image signal L_DATA and the first portion RD1 of the right-eye image signal R_DATA that are the same as each other are overlapped, only the first portion LD1 of the left-eye image signal L_ DATA and the second portion RD2 of the right-eye image signals R_DATA are different from each other.

As shown in FIG. 5, the accumulation unit 120 generates a current signal based on the left-eye image signal L_DATA and the right-eye image signal R_DATA output from the compensation unit 110, and adds the previous accumulated signal PACC and the current signal to calculate the current accumulated signal CACC. The accumulation unit 120 stores the current accumulation signal CACC in the memory 130.

If the same portion of the left-eye image signal L_DATA and the right-eye image signal R_DATA is stored in the memory 130 only once, the size of the signal stored in the memory 130 may be reduced. As a result, the size of the memory 130 can be minimized.

In an embodiment, the accumulation unit 120 combines the entire left-eye image signal L_DATA and the second portion RD2 of the right-eye image signal R_DATA that is not the same as the left-eye image signal L_DATA or entire right-eye image signal R_DATA and a first portion LD1 of the left-eye image signal L_DATA that is not the same as the right-eye image signal R_DATA to generate a current signal CC. In the following description, the accumulation unit 120 combines the entire left-eye image signal L_DATA and the second portion RD2 of the right-eye image signal R_DATA that is not the same as the left-eye image signals L_DATA to generate the current signal CC as an example.

The accumulation unit 120 adds the previous accumulated signal PACC read from the memory 130 and the current signal CC to calculate the current accumulated signal CACC. The current cumulative signal CACC is stored in the memory 130.

The current accumulated signal CACC stored in the memory 130 may be provided to the accumulation unit 120 as the previous accumulated signal PACC in a next frame.

In FIG. 6B, it is shown that the accumulation unit 120 generates the entire left-eye image signal L_DATA and the second portion RD2 of the right-eye image signal R_DATA as the current signal CC, but the present disclosure is not limited thereto. The accumulation unit 120 may generate the first portion LD1 of the left-eye image signal L_DATA and the entire right-eye image signal R_DATA as the current signal CC.

When the left-eye input signal L_IN and the right-eye input signal R_IN are received, the accumulation unit 120 may read the previous accumulated signal PACC stored in the memory 130 and restore the previous accumulated signal to the left-eye accumulated signal LACC and the right-eyed accumulated signal RACC. The accumulation unit 120 restores a portion corresponds to the entire left-eye image signal L_DATA from of the previous accumulated signal PACC read from the memory 130 to the left-eye accumulated signal LACC. The accumulation unit 120 may combine the second portion LD2 of the left-eye image signal L_DATA and the second portion RD2 of the right-eye image signal R_DATA from among the previous accumulated signals PACC read from the memory 130 to restore the same to the right-eye accumulated signal RACC.

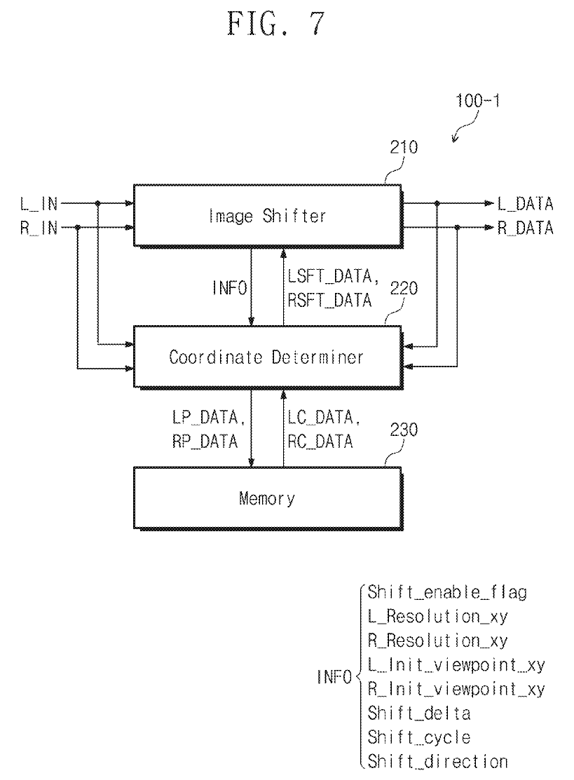

FIG. 7 is a block diagram of a driving controller 100-1 according to an embodiment of the present disclosure.

Referring to FIGS. 4 and 7, the driving controller 100-1 includes an image shifter 210, a coordinate determiner 220, and a memory 230. The image shifter 210 and the coordinate determiner may be implemented by one or more integrated circuits.

The image shifter 210 receives the left-eye input signal L_IN and the right-eye input signal R_IN, and outputs the left-eye image signal L_DATA and the right-eye image signal R_DATA.

The left-eye image signal L_DATA and the right-eye image signal R_DATA may be provided to the first display panel DP1 and the second display panel DP2. After the specific image is displayed on each of the first display panel DP1 and the second display panel DP2 for a long time, when another image is displayed, an afterimage phenomenon in which the previously displayed specific image affects the current image may be visually recognized by the user. The image shifter 210 may receive the left-eye input signal L_IN and the right-eye input signal R_IN, and set the operation mode to the shift mode when it is determined that image shift is necessary (for example, when each of the left-eye input signals L_IN and right-eye input signals R_IN is the same for a preset time).

During the shift mode, the image shifter 210 provides the shift information INFO to the coordinate determiner 220. The image shifter 210 may output the left-eye image signal L_DATA and the right-eye image signal R_DATA in which the left-eye input signal L_IN and the right-eye input signal R_IN are shifted in a predetermined direction and a predetermined distance based on a left-eye shift signal LSFT_DATA and a right-eye shift signal RSFT_DATA provided from the coordinate determiner 220.

The coordinate determiner 220 receives the left-eye input signal L_IN and the right-eye input signal R_IN, and receives the shift information INFO from the image shifter 210. The coordinate determiner 220 determines shift positions of the left-eye input signal L_IN and the right-eye input signal R_IN based on the shift information INFO. The coordinate determiner 220 reads a left-eye peripheral signal LP_DATA and a right-eye peripheral signal RP_DATA from the memory 230 based on the determined shift position. The coordinate determiner 220 may provide the left-eye peripheral signal LP_DATA and the right-eye peripheral signal RP_DATA read from the memory 230 to the image shifter 210 as the left-eye shift signal LSFT_DATA and the right-eye shift signal RSFT_DATA.

The coordinate determiner 220 receives the left-eye image signal L_DATA and the right-eye image signal R_DATA output from the image shifter 210. The coordinate determiner 220 may store the left-eye image signal L_DATA and the right-eye image signal R_DATA as a left-eye current signal LC_DATA and a right-eye current signal RC_DATA in the memory 230.

In an embodiment, the shift information INFO provided from the image shifter 210 to the coordinate determiner 220 may include a shift enable flag Shift_enable_flag, sizes L_Resoution_xy and R_Resoution_xy of each of the left-eye input signal L_IN and the right-eye input signal R_IN, an initial viewport positions L_Init_viewpoint_xy and R_Init_ viewpoint_xy, a shift distance Shift_delta, a shift period Shift_cycle, and a shift direction Shift_direction of each of the right-eye and left-eye input signals L_IN and R_IN.

The shift enable flag Shift_enable_flag during the shift mode of shifting the image may be ‘1’. When the image is not shifted, the shift enable flag Shift_enable_flag may be ‘0’.

The shift distance Shift_delta indicates how much to shift the left-eye input signal L_IN and the right-eye input signal R_IN. The shift period Shift_cycle indicates how often to shift (e.g., every few frames). The shift direction Shift_direction indicates the moving direction of the image, and may be any one of left, right, upper, lower, left+upper, left+lower, right+upper, and right+lower.

In an embodiment, at least one of the shift distance Shift_delta, the shift period Shift_cycle, and the shift direction Shift_direction may always have a constant value. The shift information INFO provided from the image shifter 210 to the coordinate determiner 220 may not include information on the shift distance Shift_delta, the shift period Shift_cycle, and the shift direction Shift_direction that always have a constant value. In this case, the coordinate determiner 220 may calculate the shift positions of the left-eye input signal L_IN and the right-eye input signal R_IN based on the preset shift distance Shift_delta, the shift period Shift_cycle, and the shift direction Shift_direction.

The shift distance Shift_delta, the shift period Shift_cycle, and the shift direction Shift_direction may have the same values for both the left-eye image and the right-eye image. However, the present disclosure is not limited thereto. When the shift distance Shift_delta, the shift period Shift_cycle, and the shift direction Shift_direction of the left-eye image and the right-eye image are different from each other, the shift information INFO may include a shift distance Shift_delta, a shift period Shift_cycle, and a shift direction Shift_direction for the left-eye images and the right-eye images, respectively.

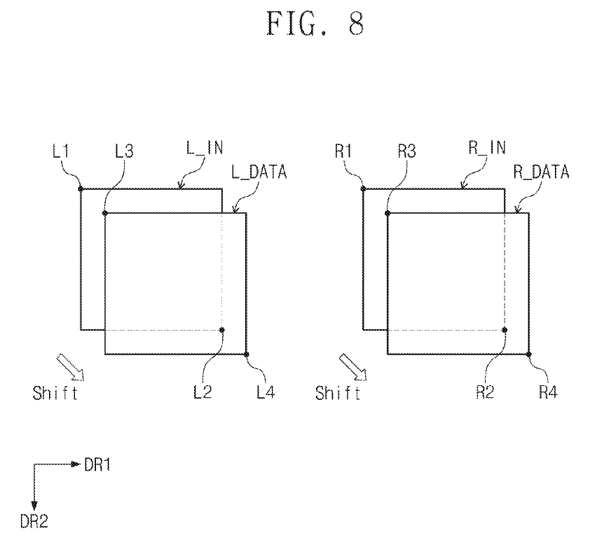

FIG. 8 illustrates an example of a left-eye image signal L_DATA corresponding to the left-eye input signal L_IN and a right-eye image signal R_DATA corresponds to the right-eye input signal R_IN.

Referring to FIGS. 7 and 8, the left-eye input signal L_IN corresponds to a viewport defined by points L1 and L2, and the right-eye input signal R_IN corresponds to the viewport defined by the points R1 and R2.

During the shift mode, the shift enable flag Shift_enable_flag of the shift information INFO provided from the image shifter 210 to the coordinate determiner 220 is ‘1’.

Sizes L_Resoution_xy and R_Resoution_xy of the left-eye image and the right-eye image of the 3D image may be a length of the first direction DR1 of the first display panel DP1 corresponding to the left-eye input signal L_IN and a length of the second direction DR1 of a second display panel DP2 corresponding to the right-eye input signal R_IN, respectively.

In an embodiment, the image shifter 210 may divide each of the left-eye input signal L_IN and the right-eye input signal R_IN into a plurality of blocks, and shift each of the left-and right-eye input signals L_IN and R_IN in units of blocks. In this case, the sizes L_Resoution_xy and R_Resoution_xy may correspond to block sizes of the left-eye input signal L_IN and the right-eye input signal R_IN, respectively.

The initial viewport positions L_Init_viewpoint_xy and R_Init_lookpoint_xy of the left-eye image and the right-eye image may indicate points L1 and L2 of the left-eyed input signal L_IN and points R1 and R2 of the right-eyed input signals R_IN.

The shift distance Shift_delta may include a value for a distance to move the points L1 and L2 of the left-eye input signal L_IN to the points L3 and L4 of the left-eye image signal L_DATA and a distance to move points R1 and R2 of the right-eye input signal R_IN to points R3 and R4 of the right-eye image signal R_DATA. In the example shown in FIG. 8, the shift distance Shift_delta may include a coordinate value indicating a distance between the points L1 and L2 of the left-eye input signal L_IN and the points L3 and L4 of the left-eye image signal L_DATA, and a coordinate value indicating the distance between the points R1 and R2 of the right-eye input signal R_IN and the point R3 and R4 of the right-eye image signal R_DATA.

In the example illustrated in FIG. 8, the shift direction Shift_direction of the left-eye input signal L_IN and the right-eye input signal R_IN to the left-eye image signal L_DATA and the right-eye image signal R_DATA is right+lower, that is, a diagonal direction between the first direction DR1 and the second direction DR2.

If the left-eye input signal L_IN is a two-dimensional (2D) image signal and the point L1 of the left-eye input signals L_IN corresponds to the coordinates (1, 1) of the first display panel DP1, a separate calculation for generating an image signal between the point L2 and the point L4 may be required to shift the left-eye input signaling L_IN to the left-eye image signaling L_DATA. This is because there is no left-eye input signal in the row following the row in which the point L2 is located. In this case, the image shifter 210 should calculate the left-eye input signal of the row following the row in which the point L2 is located through an average operation, a scaling operation, or the like based on the left-eye output signal L_IN.

In the electronic device 10 (see FIG. 3) for displaying a three-dimensional (3D) image, the memory 230 stores a 360-degree image signal. The 360-degree image includes an image outside the viewport as well as an image of the viewport displayed on the first display panel DP1 and the second display panel DP2. Therefore, a separate calculation is not required to convert the left-eye input signal L_IN and the right-eye input signal R_IN into the left-eye image signal L_DATA and the right-eye image signal R_DATA.

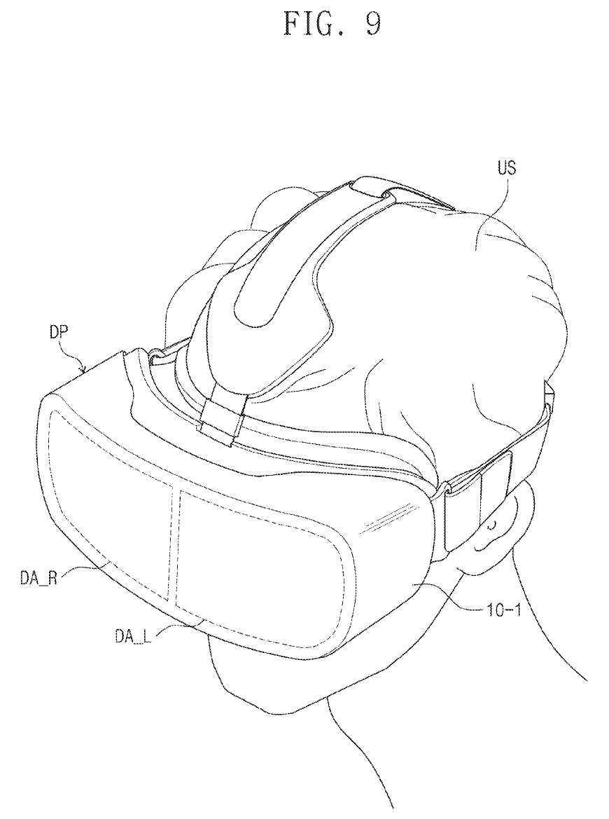

FIG. 9 is a diagram illustrating an electronic device 10-1 according to an embodiment of the present disclosure.

FIG. 9 illustrates a head mounted device as an example of the electronic device 10-1. The user US may wear the electronic device 10-1 on his/her head. The electronic device 10-1 may provide an image in a state in which the actual peripheral field of view of the user US is blocked. The user US wearing the head mounted device HMD may be more easily immersed in virtual reality.

The electronic device 10-1 includes a display panel DP. The display panel DP includes a first display area DA_L corresponding to the left-eye of the user and a second display area DA_R corresponding to the right-eye of the user.

In an embodiment, the electronic device 10-1 may include the driving controller 100 described in FIGS. 4-6B.

In an embodiment, the electronic device 10-1 may include the driving controller 100-1 described in FIGS. 7-8.

The driving controller of the electronic device 10-1 may receive the left-eye input signal L_IN and the right-eye input signal R_IN, and output the left-eye image signal L_DATA and the right-eye image signal R_DATA. Since the electronic device 10-1 operates similarly to the electronic device 100 illustrated in FIG. 4, redundant description will be omitted.

An electronic device having such a configuration may compensate for deterioration of pixels, thereby preventing deterioration of display quality. Also, deterioration of pixels in an electronic device displaying a 3D image may be compensated. Moreover, a required size of a memory may be minimized by storing an overlapping image signal among the left-eye image signals and the right-eye image signals used to compensate for deterioration of pixels only once.

An electronic device displaying a 3D image of the present invention may shift an image displayed to prevent an afterimage. In particular, since an image may be shifted with reference to a 3D image signal stored in a memory, a separate calculation for shifting the image is not required.

While the present disclosure has been described above with reference to embodiments thereof, it will be understood by those skilled in the art that various modifications and changes can be made to the present disclosure without departing from the spirit and technical scope of the present disclosure as set forth in the following claims. Therefore, the technical scope of the present disclosure should not be limited to the contents described in the detailed description of the specification, but should be determined by the claims.

What is claimed is:

1. An electronic device comprising:
a first display panel that displays an image corresponding to a left-eye image signal;
a second display panel that display an image corresponding to a right-eye image signal; and
a driving controller that receives a left-eye input signal and a right-eye input signal and outputs the left-eye image signal and the right-eye image signals,
wherein the driving controller comprises:
a memory;
an accumulation unit that reads a previous accumulated signal from the memory to restore a left-eye accumulated signal and a right-eye accumulated signal; and
a compensation unit that outputs the left-eye image signal based on the left-eye input signal and the left-eye accumulated signal, and outputs the right-eye image signal based on the right-eye input signal and the right-eye accumulated signal,
wherein the accumulation unit generates a current signal based on an entirety of the left-eye image signal and a portion of the right-eye image signal or an entirety of the right-eye image signal and a portion of the left-eye image signal, and stores a current accumulated signal obtained by adding the previous accumulated signal and the current signal in the memory.

2. The electronic device of claim 1, wherein the current accumulated signal stored in the memory in a current frame is provided to the accumulation unit as the previous accumulated signal in a next frame.

3. The electronic device of claim 1, wherein the compensation unit adds a left-eye compensation value to the left-eye input signal to generate the left-eye image signal, and adds a right-eye compensation value to the right-eye input signal, to generate the right-eye image signal.

4. The electronic device of claim 1,
wherein the left-eye image signal comprises a first portion and a second portion,
wherein the right-eye image signal comprises a first portion and a second portion, and
wherein the second portion of the left-eye image signal and the first portion of the right-eye image signal are the same as each other.

5. The electronic device of claim 4, wherein the accumulation unit generates the current signal by combining the entirety of the left-eye image signal and the second portion of the right-eye image signal.

6. The electronic device of claim 5, wherein the left-eye image signal corresponds to a viewport by a left-eye of a user, and the left-eye image signal corresponds to a viewport by a right-eye of the user.

7. The electronic device of claim 5, wherein the accumulation unit restores a portion corresponding to the entirety of the left-eye image signal from among the previous accumulated signal from the memory as the left-eye accumulated signal, and restores the right-eye accumulated signal by combining the second portion of the left-eye image signal and a portion corresponding to the second portion of the right-eye image signal.

8. An electronic device comprising:
a first display panel for displaying an image corresponding to a left-eye image signal;
a second display panel for displaying an image corresponding to a right-eye image signal; and
a driving controller that receives a left-eye input signal and a right-eye input signal, and outputs the left-eye image signals and the right-eye image signals,
wherein the driving controller comprises:
a memory;
an image shifter that outputs shift information during a shift mode; and
a coordinate determiner that determines a shift position of the left-eye input signal and a shift position of the right-eye input signal based on the shift information, reads a left-eye peripheral signal and a right-eye peripheral signal from the memory based on a determined shift position, and provides a left-eye shift signal and a right-eye shift signal to the image shifter,
wherein the image shifter outputs the left-eye image signal and the right-eye image signal based on the left-eye shift signal and the right-eye shift signal.

9. The electronic device of claim 8, the coordinate determiner receives the left-eye image signal and the right-eye image signal from the image shifter, and stores the left-eye image signal and the right-eye image signal in the memory as a left-eye current signal and a right-eye current signal.

10. The electronic device of claim 8, wherein the shift information includes a shift enable flag indicating the shift mode.

11. The electronic device of claim 10, wherein the shift information further includes a size and an initial viewport position of each of the left-eye input signal and the right-eye input signal.

12. The electronic device of claim 11, wherein the shift information further includes a shift distance, a shift period, and a shift direction of each of the left-eye input signal and the right-eye input signal.

13. The electronic device of claim 8, wherein the memory stores an image signal corresponding to a 360-degree image, and
wherein the coordinate determiner reads the left-eye peripheral signal and the right-eye peripheral signal from among the image signal stored in the memory according to the determined shift position.

14. An electronic device comprises:
a display panel including a first display region for displaying an image corresponding to a left-eye image signal and a second display region for displaying an image corresponding to a right-eye image signal; and
a driving controller that receives a left-eye input signal and a right-eye input signal, and outputs the left-eye image signal and the right-eye image signal,
wherein the driving controller comprises:
a memory;
an accumulation unit that read a previous accumulated signal from the memory and restore a left-eye accumulated signal and a right-eye accumulated signal; and
a compensation unit that output the left-eye image signal based on the left-eye input signal and the left-eye accumulated signals, and to output the right-eye image signal based on the right-eye input signal or the right-eye accumulated signals,
wherein the accumulation unit generates a current signal based on an entirety of the left-eye image signal and a portion of the right-eye image signal or an entirety of the right-eye image signal and a portion of the left-eye image signal, and stores a current accumulated signal obtained by adding the previous accumulated signal and the current signal in the memory.

15. The electronic device of claim 14, wherein the current accumulated signal stored in the memory in a current frame is provided to the accumulation unit as the previous accumulated signal in a next frame.

16. The electronic device of claim 14, wherein the compensation unit adds a left-eye compensation value to the left-eye input signal to generate the left-eye image signal, and adds a right-eye compensation value to the right-eye input signal to generate the right-eye image signal.

17. The electronic device of claim 14, wherein the left-eye image signal includes a first portion and a second portion,
wherein the right-eye image signal includes a first portion and a second portion, and
wherein the second portion of the left-eye image signal and the first portion of the right-eye image signals are the same as each other.

18. The electronic device of claim 17, wherein the accumulation unit generates the current signal by combining the entirety of the left-eye image signal and the second portion of the right-eye image signal.

19. The electronic device of claim 17, wherein the left-eye image signal corresponds to a viewport by a left-eye of a user, and the left-eye image signal corresponds to the viewport by a right-eye of the user.

20. The electronic device of claim 19, wherein the accumulation unit restores a portion corresponding to the entirety of the left-eye image signal from among the previous accumulated signal from the memory as the left-eye accumulated signal, and restores the right-eye accumulated signal by combining the second portion of the left-eye image signal and a portion corresponding to the second portion of the right-eye image signal.
